(19) United States
(12) Patent Application Publication
(10) Pub. No.: US 2004/0024882 A1
(43) Pub. Date: Feb. 5, 2004

(54) Enabling authorised-server initiated internet communication in the presence of network address translation (NAT) and firewalls

(76) Inventors: Paul Austin, Dunnington (GB); Kenneth Tindell, Naburn (GB)

Correspondence Address: Brent P. Johnson, Esq., SHERIDAN ROSS P.C., Suite 1200, 1560 Broadway, Denver, CO, 80202-5141, US

(21) Appl. No.: 10/214,378

(22) Filed: Aug. 6, 2002

(30) Foreign Application Priority Data
Jul. 30, 2002 (GB) 0217592.5

(51) Int. Cl. G06F 15/16

(52) U.S. Cl. 709/227

(57) ABSTRACT

There is disclosed a method and system for enabling authorised-server initiated Internet communication between a client device and a server device by way of an authorisation portal. When the server wishes to initial Internet communication with a particular client, the server sends an Internet message to the authorisation portal. The authorisation portal then relays the message to the client device by way of a communications protocol other than the Internet, for example SMS. The client, upon receipt of the message, then establishes an Internet connection to the server. In this way, a server can initiate Internet communication with a client despite the presence of NAT or firewalls or the like that would otherwise prevent server initiated communication.

The present invention relates to methods and software for using asynchronous messaging systems, for example including (but not limited to) Global System for Mobile communication Short Message Service (GSM SMS), European Radio Message System (ERMES), or UDP sent over a Virtual Private Network, to allow Internet connected servers to initiate Internet communication with clients without the clients being subject to unsolicited network traffic or needing an always-on Internet connection.

### BACKGROUND TO THE PRESENT INVENTION

The present application uses the terms “host”, “client” and “server” to refer to systems that communicate using the Internet. The Internet is generally defined as a collection of data communication networks that use the TCP/IP suite of protocols, and is the communication infrastructure used by applications such as the World Wide Web (“the Web”), electronic mail (“e-mail”) and File Transfer Protocol (“FTP”). A host is any system that can communicate using the Internet. Examples of hosts include, but are not limited to, computers, automotive systems, consumer electronic products, metering equipment and other embedded systems that contain microcontrollers or microprocessors. A server is a host that offers a service that is accessed by communication over the Internet. A server will typically, but not always, have an always-on Internet connection as discussed in more detail hereinbelow. A client is a host that accesses the services of a server by communication over the Internet. Any individual host may be a client for some services and a server for others. In other words, a host may be a client and a server at the same time.

At present hosts can be connected to the Internet in two ways:

Dial-up: this is where a host contains some device, such as a modem, that can, at the host's instigation, create a physical network connection (a means of carrying digital signals) to some similar device owned by an Internet Service Provider (ISP). This ISP owned device, such as another modem, is attached to a special kind of host, usually called a router, which is permanently connected to the Internet backbone (this being the permanently connected communications network that carries IP packets between ISPs). The host and the router then run the TCP/IP protocol suite over their physical network connection. The router forwards the host's IP packets to and from the rest of the Internet.

Always-on: this is where the host always has a physical network connection to an ISP's router and the TCP/IP protocol suite is always running over this physical network connection.

Dial-up connection is used for three principal reasons. Firstly, at present most physical network connections between a host and an ISP make use of a circuit switched infrastructure provided by a telephone company. This circuit switched infrastructure, which may be wired (telephone lines), fibre optic or wireless, was originally designed for voice telephony and for two devices to be connected, resources must be allocated to the connection for the duration of the connection. Consequently, the telephone companies usually charge for the duration of the connection rather than the amount of data that passes along it (in the same way they would for a voice call). For reasons of cost, therefore, a client usually only maintains a physical network connection to an ISP when it wishes to communicate with servers on the Internet.

The second reason for dial-up connections is also related to cost. Although there are many hosts in existence, very few of them are involved in communication over the Internet at any one time. This means that an ISP can support many more hosts with the same number of in-coming telephone lines and modems using temporary dial-up connections than if hosts were always connected to the ISP's routers. Dial-up therefore allows the ISP to charge less for its services.

Thirdly, in the case of cell-based wireless communication systems like GSM, it is likely that there is insufficient capacity in the communication system to support a large number of simultaneous connections from hosts in the same cell. A large number of hosts in one cell can only be supported if they only make relatively short duration dial-up connections over the wireless communications system.

If a particular client that uses a dial-up connection is to communicate with a particular server, a physical network connection must be established between the client and its ISP, as above. If the client is initiating the communication then it is straightforward for the client to establish this physical connection. Client initiated connection is the typical usage mode for dial-up connections. For example, when a Web browser is started on a PC, the PC will create a dial-up connection to an ISP.

If, however, a server wishes to initiate communication with a client then the situation is more complicated. It would, in principle, be possible for an ISP to establish a physical network connection to a client when the ISP receives IP packets for the client from a server. This is not in general done because of charging issues. When a client initiates communication and establishes a physical network connection to an ISP, it is clear that the client should pay for the connection. If a server wishes to communicate with the client then it is much harder to decide who should pay for the connection. If the communication relates to a service that the client wants then it would be correct for the ISP to pass on the connection charges to the client. If, however, some server sends unsolicited and unwanted e-mail (“SPAM”) to the client, the client may not wish to pay for the connection. For many applications it would be very useful if a server could initiate communication. For example, a traffic flow-monitoring server may wish to send notification of traffic congestion to a client located in a car.

There are two further problems related to Internet communication initiated by servers that apply irrespective of whether the client has an always-on or a dial-up connection to the Internet. The first is Network Address Translation (NAT). A host connected to the Internet is identified by an IP address. For two hosts connected the Internet to communicate they must both have unique IP addresses. IP addresses which are unique across the whole Internet are called public IP addresses. An IP address is a 32 binary digit number. The use of the binary digits within IP addresses is structured to reflect network topology and real-world organisations. As a consequence not all of the 232 possible IP addresses can be used and there are not enough public IP addresses for every host to have its own. ISPs overcome this problem using NAT. When a host creates a dial-up connection to an ISP's router, the host is allocated a private IP address by the ISP for the duration of the connection. This private IP address uniquely identifies the host within the ISP's network but not necessarily across the whole Internet (certain special ranges of IP addresses are reserve for this purpose).

When a host wishes to communicate with a host external to the ISP's own network, the ISP's router that forwards the internal host's IP packets onto the Internet backbone will replace the private source address in the IP packets with its own public IP address. The router will also remember that the internal host has sent IP packets to the external host. When the external host replies, it will send its IP packets to the ISP's router—since the IP packets it receives contain the router's public IP address as their source address. The ISP's router will realise that the IP packets are a reply to the internal host and will forward the packets to the internal host.

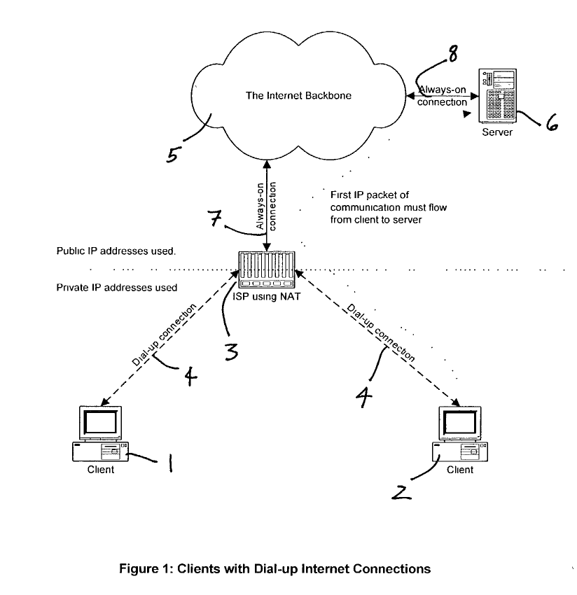

Hosts external to the ISP cannot directly communicate with hosts on the IP's internal network because those hosts on the internal network do not have public IP addresses. Hosts external to the ISP can only communicate with the ISP's routers. NAT only works if a host (usually a client) internal to the ISP sends the first IP packets (for example, opening a TCP connection) of a communication so that a router can “learn” to translate between the host's private IP address and the router's public IP address (see FIG. 1).

Firewalls are the second problem related to server initiated Internet communication. A firewall is a device that restricts what IP packets are allowed to enter and leave an organisation's internal TCP/IP network. Typically, a firewall will be configured to allow communication between a host in the organisation's internal network and a host external to the organisation's network if the first IP packets of the communication are sent by the internal host. This configuration is used to stop unsolicited IP packets being sent to hosts within the organisation.

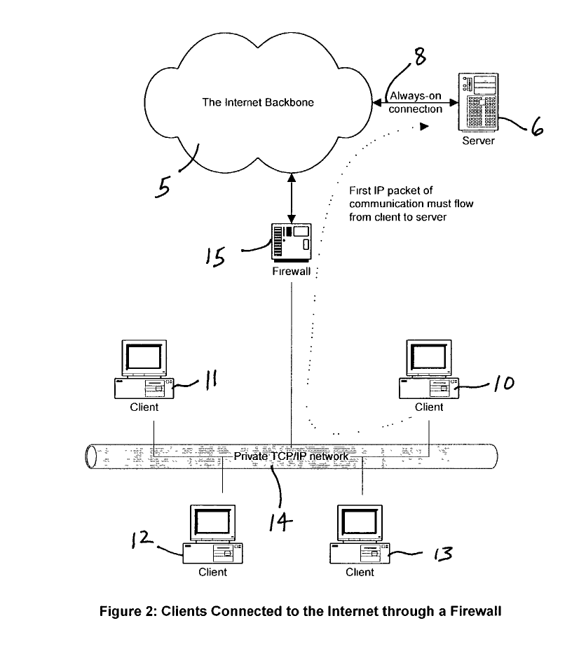

Organisations may use technology such as Virtual Private Networks (“VPN”s) to connect hosts together to form a virtual TCP/IP network even if the hosts are connected to different physical networks. That is, some hosts in the virtual network may be attached to the same physical network; others may be connected to the virtual network via channels through the Internet, or by any other means. Hosts within the virtual network may send each other IP packets without restriction. Hosts external to the virtual network may not be able to send unsolicited IP packets into the virtual network because typically the VPN is connected to the Internet backbone through NAT or a firewall. Embodiments of the present invention also apply to communication between clients located inside such a virtual network and servers located external to the virtual network (see FIG. 2).

A new TCP/IP protocol suit, IPv6 (RFC 2460; “Internet Protocol, Version 6 (Ipv6)”; S. Deering, R. Hinden; December 1998), alleviates the shortage of IP addresses. Other new network technology, such as GPRS and ADSL, allows clients to have always-on Internet connections. Despite this, many ISPs and other organisations managing Internet communication continue to use NAT or firewalls for reasons including stopping malicious external hosts from sending unsolicited and unwanted IP packets to hosts inside the organisation. This is especially important with technologies like GPRS where hosts may have to pay for IP packets that they receive.

Therefore, even in the presence of IPv6 and new network technologies that provide always-on connections, the problems of server initiated Internet communication identified above still exist.

At present, in applications where a server must be able to initiate Internet communication with a client, the client must have an always-on Internet connection and must not be subject to NAT. This will likely be expensive for the client as it will need a dedicated physical network connection to its ISP, dedicated capacity at its ISP and must have a scarce public IP address. As previously explained, in a cell based wireless communications system a true always-on connection may not even be possible. Further, to stop clients from receiving unsolicited IP packets, NAT or a firewall may be used even if the client does have an always-on Internet connection.

### SUMMARY OF THE PRESENT INVENTION

According to a first aspect of the present invention, there is provided a method of initiating Internet communication between a client device and a server device, wherein the server is adapted to cause a message to be delivered to the client by way of a communications protocol other than the Internet, and the client, upon receipt of the message, establishes an Internet or the like connection to the server.

According to a second aspect of the present invention, there is provided a client device adapted to establish an Internet connection with a server device upon receipt of a message transmission which is initially triggered by the server, the message being received by the client by way of a communications protocol other than the Internet.

According to a third aspect of the present invention, there is provided a server device adapted to cause a message to be transmitted to a client device by way of a communications protocol other than the Internet, the client upon receipt of the message then establishing an Internet connection with the server.

According to a fourth aspect of the present invention, there is provided a system comprising at least a client device and a server device, wherein the server is adapted to cause a message to be transmitted to the client by way of a communications protocol other than the Internet, and wherein the client is adapted, upon receipt of the message, to establish an Internet connection with the server.

According to a fifth aspect of the present invention, there is provided an authorisation portal device adapted, upon receipt of a signal from a predetermined server device, to transmit a message to a predetermined client device by way of a communications protocol other than the Internet, the client establishing an Internet connection with the server upon receipt of the message.

Embodiments of the present invention may use an asynchronous messaging system such as, but not limited to, GSM SMS, the European Radio Message System (ERMES), RDS (Radio Data System), long wave (LW) radio or other modulated radio frequency (RF) signals, Trafficmaster® or UDP sent over a Virtual Private Network as the communications protocol other than the Internet. The messaging system allows server initiated Internet communication for clients that have dial-up connections and/or that are subject to NAT or a firewall—that is, it simulates an always-on connection that is not subject to NAT or a firewall.

The message may be transmitted by an “authorisation portal” to signal to a client when the client is not currently connected to the Internet or the client cannot be sent an IP packet by a host external to the client's organisation.

An authorisation portal is a device (for example, but not limited to, a computer or a network router) that has permission to signal a client to establish a connection to the Internet. An authorisation portal may signal to a client at any time by sending a message to the client using, for example, an asynchronous messaging system as defined hereinbefore. For example the Global System for Mobile communication Short Message Service (GSM SMS) may be used. In this case, the authorisation portal may send SMS messages by using, amongst other methods, a GSM modem or an SMS Service Centre. The client may receive SMS messages by using, amongst other methods, a GSM modem.

Advantageously there is provided a means for a client to determine that a message sent using an asynchronous message system has been sent by a trusted authorisation portal.

When the authorisation portal sends a signal to the client it sends to the client an asynchronous messaging system message that may include, but it is not limited to, an identity of the client, an identity of the portal and a non-repeating value (for example a date and/or time, a value generated by a hardware counter or clock, a random number, a nonce or the like). The authorisation portal may attach a digital signature of the message to a main body of the message. On receiving the message, the client may check that the client identity contained in the message is its own, that the authorisation portal identity contained in the message identifies an authorisation portal that it trusts, that it has not seen the non-repeating value before, and that the digital signature attached to the message is correct. If any of these checks fail, the message may be discarded.

A digital signature can be generated by a first party applying a special mathematical function to the data to be signed. The output of the function is the signature. The function is such that by examining the data and the signature a second party can be certain that the data has not been changed since the signature was generated and that the first party, and only the first party, generated the signature. Many different digital signature functions are possible. The present invention does not rely on any particular function. Two alternatives are presented here as examples. Any other function with the properties just described could also be used.

### EXAMPLE 1

### A One-Way-Function with a Shared Secret

By some means, such as, but not limited to, secure Internet communication, manual configuration or factory programming, some data, called a “shared secret”, whose value is known only to the client and the trusted authorisation portal, is stored by the client in a memory device contained in or attached to the client and by the authorisation portal in a memory device contained in or attached to the authorisation portal. The authorisation portal generates a digital signature by applying a one-way-function to the message and the shared secret. For example, where F is the one-way-function, S is the shared secret and M is the message, the signature will be F(M,S). On receiving the message, the client regenerates the signature by applying the same one-way-function to the message and its copy of the shared secret. If the signature that the client generates does not match the signature attached to the message then the message is discarded.

A one-way-function is a mathematical function that takes an input X and produces an output Y. One-way-functions have the property that the input X cannot be derived from the output Y. Since the shared secret, which is known only to the client and the authorisation portal, is included in the input to the one-way-function, only the client and authorisation portal can generate the signature by means other than guessing. A one-way-function that has many possible output values is used to help prevent an attacker guessing the signature for a message that it has created. Since the input of the one-way-function cannot be derived from the output, an attacker cannot deduce the shared secret if the attacker captures a message and its signature. Suitable one-way-functions include, but are not limited to, MD5 (Message Digest 5 algorithm), SHA-1 (US Secure Hash Algorithm 1), HMAC-MD5 (Keyed-Hashing for Message Authentication MD5) or HMAC-SHA (Keyed-Hashing for Message Authentication SHA-1).

### EXAMPLE 2

### Public-Key Cryptography

Some data, called a “private key”, whose value is known only to the trusted authorisation portal, is stored by the authorisation portal in a memory device contained in or attached to the authorisation portal. By some means, such as, but not limited to, secure Internet communication, manual configuration or factory programming, some data, called a “public key”, that is related to the private key in a special way, is stored by the client in a memory device contained in or attached to the client. The authorisation portal generates a digital signature by first applying a compression function to the message and then encrypting the output of the compression function using a public-key encryption algorithm keyed with the private key. On receiving the message, the client decrypts the signature using the corresponding public-key decryption algorithm keyed with the public key. The client then applies the same compression function to its copy of the message and checks that the output of the compression function is the same as the decrypted signature. If output of the compression function is not the same as the decrypted signature then the message is discarded.

Public-key cryptography uses an encryption algorithm and a decryption algorithm and two related keys called the private key and the public key. The algorithms and keys are such that some data encrypted with the private key can only be decrypted with the public key. Likewise, some data encrypted with the public key can only be decrypted with the private key. A consequence of this is that if an authorisation portal keeps its private key secret and clients know the authorisation portal's public key, then a client that successfully decrypts some data using the public key can be certain that the data was encrypted by the authorisation portal. Suitable public-key encryption schemes include, but are not limited to, RSA (Rivest-Shamir-Adleman).

A compression function is a mathematical function that takes an input X and produces an output Y. Compression functions have the property that Y usually requires fewer binary digits to represent than X, but that it is very difficult to predict Y from X other than by applying the function to X. Suitable compression functions include, but are not limited to, MD5 and SHA-1.

Embodiments of the present invention allow the client to ensure that an asynchronous messaging system message was sent to it by an authorisation portal that it trusts and that the message has not been changed after it was sent. The presence of the non-repeating value allows the client to detect and discard old messages that the client has previously received. Such messages may have been replayed accidentally by an authorisation portal or deliberately by an attacker. Suitable non-repeating values include, but are not limited to, a date and/or time, a value generated by a hardware counter or clock, a random number, a nonce or the like.

Embodiments of the present invention may provide a means for a trusted authorisation portal to signal to a client that the client should establish TCP/IP communication with a particular server, if necessary establishing a dial-up connection to the Internet first. The term TCP/IP communication is used to mean any communication mechanism that uses the TCP/IP protocol suite. This includes, but is not limited, to TCP and UDP packet exchanges.

An authorisation portal may signal to the client to establish TCP/IP communication with the particular server. The asynchronous message used to send the signal includes, explicitly or implicitly, the identity of the particular server. On receipt of the message the client performs a check to ensure that the message was sent by a trusted authorisation portal. If the message was sent by a trusted authorisation portal then the client may respond as follows:

1. If client does not already have a connection to the Internet it establishes a dial-up connection to its ISP.

2. The client establishes TCP/IP communication with the server identified explicitly or implicitly by the message. Since the TCP/IP communication is established by the client, that is the first IP packet(s) is (are) sent by the client, the TCP/IP communication will operate correctly when the client's ISP is using Network Address Translation (NAT) or the organisation containing the client is using a firewall. (TCP/IP communication is established by means including, but not limited to, opening a TCP connection or sending a UDP packet.)

Embodiments of the present invention may provide a means for a trusted server to send a request to a trusted authorisation portal in such a way that the authorisation portal can be sure of the server's identity.

In order to achieve this, the server may use a secure Internet communications protocol such as, but not limited to, SSL (Secure Sockets Layer) or TLS (Transport Layer Security) to communicate with the authorisation portal. Such secure Internet protocols use means such as, but not limited to, “digital certificates” to prove the identity of the authorisation portal to the server. Examples of digital certificates include, but are not limited to, X.509 (directory authorisation framework) certificates. The server may then use a means such as, but limited to, its own digital certificate or secret password to prove its identity to the authorisation portal. Once the server and portal are sure of each other's identity, the authorisation portal will accept requests from the server sent over the secure Internet communication protocol.

Some embodiments of the present invention may, by some means including, but not limited to, manual configuration, allow an owner (i.e. a human or machine entity that is authorised to manage the activities of a client) of a client to inform an authorisation portal trusted by the client that a particular server is permitted to signal to the client as hereinbefore described. The authorisation portal will only signal to the client in response to a request from the particular server if the owner of the client has so informed the authorisation portal.

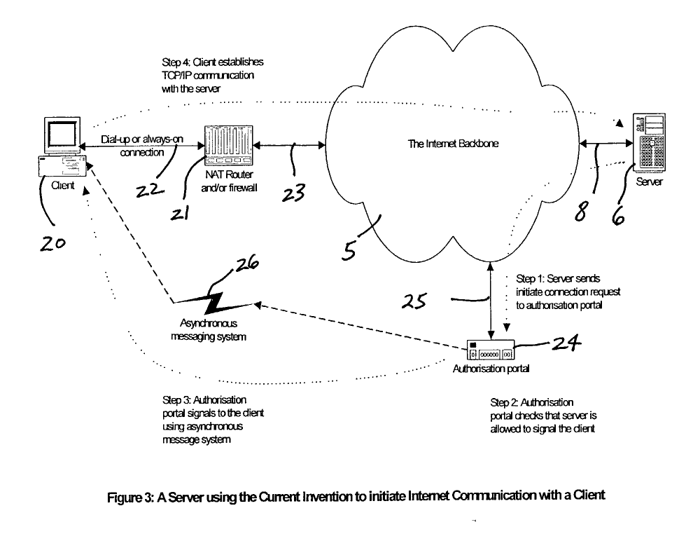

Advantageously, control information may be included in an asynchronous message sent by an authorisation portal to a client. This control information includes, but is not limited to, the priority with which the client should act on the message and the reason why the server wishes to communicate with the client (see FIG. 3). The control information may alternatively or additionally include one or more commands in addition to a simple instruction to establish an Internet connection. For example, the control information may instruct the client to establish an Internet connection with the server and automatically to transfer predetermined data such as a status report or a data log or the like.

Advantages/Features of Embodiments of the Present Invention Include:

1. A server can initiate Internet communication with a client even if the client does not have an always-on Internet connection, or the client is subject to Network Address Translation (NAT), or the client is part of an organisation that uses a firewall to stop hosts that are external to the organisation from sending unsolicited IP packets to hosts that are within the organisation.

2. Only an authorisation portal trusted by a client can signal the client, using a digitally signed asynchronous messaging system message, to establish TCP/IP communication with a server. Only a server so permitted by the owner of a client may instruct an authorisation portal trusted by the client to signal to the client to establish a TCP/IP session with a server. Thus the owner of a client may control which servers are allowed to cause the client to establish TCP/IP communication with servers.

3. Where embodiments of the present invention are used with clients that are subject to NAT, or clients that are part of an organisation that uses a firewall to stop hosts that are external to the organisation from sending unsolicited IP packets to hosts that are within the organisation, then only servers so permitted by the owners of clients may initiate Internet communication with the clients. Other hosts external to NAT or the firewall may not send IP packets to the clients. This prevents clients from receiving unsolicited IP packets. In particular, in environments where clients must pay to receive IP packets, the clients only pay for packets that their owners have authorised.

4. Since server initiated Internet communication is possible in the presence of NAT, embodiments of the present invention allow server initiated Internet communication without clients needing public IP addresses.

5. Because server initiated Internet communication is possible in 4) above without the need for clients to have public IP addresses, embodiments of the present invention allow server initiated Internet communication without the need to adopt IPv6 (Internet Protocol version 6) to overcome the shortage of IPv4 (Internet Protocol version 4) addresses.

For a better understanding of the present invention and to show how it may be carried into effect, reference shall now be made by way of example to the accompanying drawings, in which:

FIG. 1 shows a conventional client-server architecture with dial-up Internet connections;

FIG. 2 shows a conventional client-server architecture implementing a firewall;

FIG. 3 shows a client-server architecture embodying the present invention; and

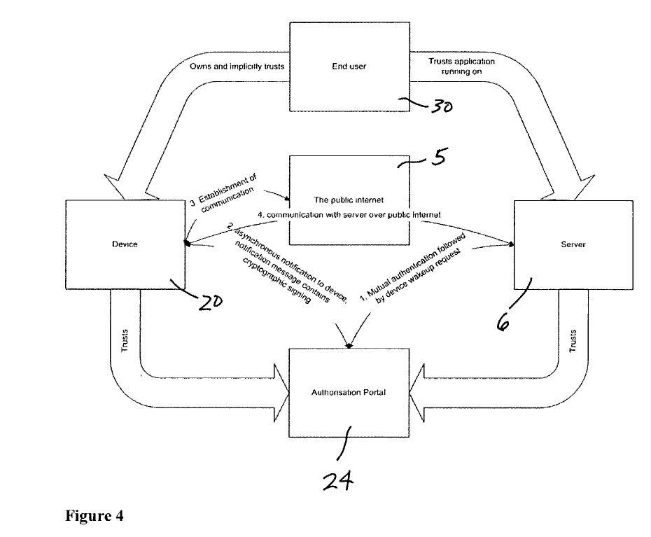

FIG. 4 illustrates trust relationships between an end user, an embedded device, a server and an authorisation portal in accordance with an embodiment of the present invention.

FIG. 1 shows a conventional architecture comprising two client devices 1, 2 (each of which may, for example, be an embedded device) that are each connectable to an ISP 3 by way of dial-up connections 4, 4′. The ISP 3 uses NAT, which means that each client 1, 2 has a private IP address known to and used by only the ISP 3 dedicated to the clients 1, 2. The ISP 3 has a public IP address that enables it to communicate directly with other servers 6 or the like over the public Internet backbone 5, in this example by way of always-on connections 7, 8. Where a client 2, for example, needs to communicate with the remote server 6, it must first establish a dial-up connection 4′ to the ISP 3. The client 2 then transmits at least one IP packet including its private IP address and the public IP address of the remote server 6, the IP packet being sent initially to the ISP 3. The ISP 3 notes the private IP address of the client 2 that sent the IP packet and translates this by way of NAT into its own public IP address before relaying the IP packet to the remote server 6 by way of the Internet backbone 5. A response from the remote server 6 may then be sent over the Internet backbone 5 to the client 2 by way of a response IP packet addressed to the public IP address of the ISP 3. The ISP 3, by using NAT, is able to determine from data included in the response IP packet that the IP packet is intended for the client 2, and will translate the public IP address information in the response IP packet to the private IP address of the client 2 before relaying the response IP packet over the dialup connection 4′. It will be appreciated that it is not possible in this conventional architecture for a remote server 6 to initiate communication with a particular client 1, 2, since the private IP addresses of the clients 1, 2 are not known to the remote server 6.

FIG. 2 shows an alternative conventional architecture comprising clients 10, 11, 12 and 13 which are connected together as part of a private TCP/IP network 14 (for example a LAN or WAN operated by a particular company or organisation). The private TCP/IP network 14 is provided with a firewall device 15 through which it may communicate with the outside world by way of the Internet backbone 5. In FIG. 2, the firewall 15 is also configured as an ISP, although the firewall 15 may alternatively connect to the Internet backbone by way of a separate or remote ISP 3 as shown in FIG. 1. There is also shown a remote server 6 with an always-on connection 8 as in FIG. 1. The firewall 15 is configured so as to allow communication between a client 10 internal to the private TCP/IP network 14 and the remote server 6 only if the first IP packets of the communication are sent by the internal client 10, thereby preventing unsolicited IP packets being sent to a client 10 within the private network 14 from outside.

FIG. 3 shows an architecture in accordance with an embodiment of the present invention. As before, there is shown a client device 20 that may communicate over the Internet backbone 5 with a remote server 6 by way of a NAT router and/or a firewall 21. The client 20 may have a dial-up or always-on connection 22 to the NAT router/firewall 21, which in turn has a dial-up or always-on connection 23 to the Internet backbone 5. The server 6 is provided with an always-on connection 8 to the Internet backbone 5. There is additionally provided an authorisation portal 24 having an always-on connection 25 to the Internet backbone 5. When the remote server 6 wishes to establish communication with the client 20, it sends an “initiate communication” signal to the authorisation portal 24 by way of the Internet backbone 5. The “initiate communication” signal generally includes information identifying the particular client 20 that is to establish communication with the server 6. Typically, the client 20 has some form of unique identifier and the authorisation portal 24 keeps a database mapping the identifiers of various clients 20 to whatever address is needed for an appropriate asynchronous messaging protocol 26. The type of client 20 identifier may be whatever is most suited for the application. For example, where the clients 20 are embedded devices in motor vehicles and the asynchronous messaging protocol 26 is GSM SMS, an appropriate client identifier could be a registration number or Vehicle Identification Number (VIN) for each motor vehicle. The messaging address may then be a telephone number of a GSM modem located in the motor vehicle and associated with the embedded client 20. The server 6 may then send a message along the lines of “I want to communicate with the embedded client in the motor vehicle with registration number X123 ABC” to the authorisation portal 24 by way of the Internet backbone 5. The authorisation portal 24 then looks up registration number “X123 ABC” in its database to find a telephone number (e.g. “07776 123 456”) for the GSM modem associated with the embedded client 20 in the motor vehicle in question. The authorisation portal 24 then sends an SMS message to the GSM modem with number “07776 123 456” associated with the client 20 by way of the asynchronous messaging protocol 26. The client 20 receives the message from the authorisation portal 24, checks to see that the message has come via a predetermined authorisation portal 24 trusted by the client 20 (and optionally that the message has originated from a remote server 6 also trusted by the client 20 and/or the authorisation portal 24) and then acts on the message, for example by establishing TCP/IP communication with the remote server 6 by way of the NAT router/firewall 21 and the Internet backbone 5. It is important to appreciate that, in this example, it is not necessary for the server 6 to know the messaging address or private IP address of the client 20, since NAT effectively prevents the server 6 from ever knowing the private IP address for a client 20.

FIG. 4 illustrates the various trust relationships required in embodiments of the present invention. An end user 30 owns and implicitly trusts a client device 20, and also trusts applications running on a predetermined remote server 6. The client 20 in turn trusts a predetermined authorisation portal 24, as does the remote server 6. When the server 6 wishes to communicate with the client 20, the server 6 must first establish mutual authentication with the authorisation portal 24 followed by transmission to the authorised portal 24 (by way of the Internet backbone 5) of a client “wake-up request”. The authorisation portal 24 then sends an asynchronous notification message to the client 20, the message containing a cryptographic digital signature or the like that allows the client 20 to authenticate the authorisation portal 24 and/or the remote server 6. The client 20 is then able to establish a connection to the remote server 6 by way of the Internet backbone 5.

The preferred features of the invention are applicable to all aspects of the invention and may be used in any possible combination.

Throughout the description and claims of this specification, the words “comprise” and “contain” and variations of the words, for example “comprising” and “comprises”, mean “including but not limited to”, and are not intended to (and do not) exclude other components, integers, moieties, additives or steps.

1. A method of initiating Internet communication between a client device and a server device, wherein the server is adapted to cause a message to be delivered to the client by way of a communications protocol other than the Internet, and the client, upon receipt of the message, establishes an Internet or the like connection to the server.

2. A method according to claim 1, wherein the server device initially transmits the message to an authorisation portal by way of the Internet or the like, and wherein the authorisation portal relays the message to the client by way of the communications protocol other than the Internet.

3. A method according to claim 2, wherein the authorisation portal, when relaying the message to the client, adds at least one data item selected from a group comprising: a client identity, an authorisation portal identity and a non-repeating value.

4. A method according to claim 2, wherein the authorisation portal, when relaying the message to the client, adds a digital signature of the message thereto.

5. A method according to claim 1, wherein the communications protocol other than the Internet is selected from a group comprising: GSM SMS, ERMES, RDS, LW radio and other RF signals, and UDP sent over a VPN.

6. A client device adapted to establish an Internet connection with a server device upon receipt of a message transmission which is initially triggered by the server, the message being received by the client by way of a communications protocol other than the Internet.

7. A client device as claimed in claim 6, the client being provided with a receiver adapted to receive a message from an authorisation portal by way of the communications protocol other than the Internet, the message initially being sent to the authorisation portal by the server by way of the Internet or the like.

8. A client device as claimed in claim 6, the client being provided with a modem adapted to establish the Internet connection with the server upon receipt of the message.

9. A server device adapted to cause a message to be transmitted to a client device by way of a communications protocol other than the Internet, the client upon receipt of the message then establishing an Internet connection with the server.

10. A server device as claimed in claim 9, the server being adapted to send a message to an authorisation portal by way of the Internet or the like, the message being relayed to the client by the authorisation portal by way of the communications protocol other than the Internet.

11. A system comprising at least a client device and a server device, wherein the server is adapted to cause a message to be transmitted to the client by way of a communications protocol other than the Internet, and wherein the client is adapted, upon receipt of the message, to establish an Internet connection with the server.

12. A system as claimed in claim 11, further comprising an authorisation portal adapted to receive a message sent by the server by way of the Internet or the like, and to relay the message to the client by way of the communications protocol other than the Internet.

13. A system as claimed in claim 12, wherein the authorisation portal is adapted, when relaying the message to the client, to add to the message at least one data item selected from a group comprising: a client identity, an authorisation portal identity and a non-repeating value.

14. A system as claimed in claim 12, wherein the authorisation portal is adapted, when relaying the message to the client, to add to the message a digital signature of the message.

15. A system as claimed in claim 12, wherein the communications protocol other than the Internet is selected from a group comprising: GSM SMS, ERMES, RDS, LW radio and other RF signals, and UDP sent over a VPN.

16. An authorisation portal device adapted, upon receipt of a signal from a predetermined server device, to transmit a message to a predetermined client device by way of a communications protocol other than the Internet, the client establishing an Internet connection with the server upon receipt of the message.

17. An authorisation portal as claimed in claim 16, adapted to receive the signal sent by the server by way of the Internet or the like, and to transmit the message to the client by way of the communications protocol other than the Internet.

18. An authorisation portal as claimed in claim 16, the authorisation portal being adapted, when transmitting the message to the client, to add to the message at least one data item selected from a group comprising: a client identity, an authorisation portal identity and a non-repeating value.

19. An authorisation portal as claimed in claim 16, the authorisation portal being adapted, when transmitting the message to the client, to add to the message a digital signature of the message.

20. An authorisation portal as claimed in claim 16, wherein the communications protocol other than the Internet is selected from a group comprising: GSM SMS, ERMES, RDS, LW radio and other RF signals, and UDP sent over a VPN.

21. An authorisation portal as claimed in claim 16, wherein the authorisation portal has access to a database mapping client identities to messaging addresses used by the communications protocol other than the Internet.

22. A method of initiating Internet communication between a client device and a server device, wherein the server initially transmits a message to an authorisation portal by way of the Internet or the like, wherein the authorisation portal relays the message to the client by way of a communications protocol other than the Internet, and wherein the client, upon receipt of the message, establishes an Internet or the like connection to the server.

23. A system comprising at least a client device, an authorisation portal and a server device, wherein the server is adapted to transmit a message to the authorisation portal by way of the Internet or the like, wherein the authorisation portal is adapted to relay the message to the client by way of a communications protocol other than the Internet, and wherein the client is adapted, upon receipt of the message, to establish an Internet connection with the server.

24. A method of initiating Internet communication between a client device and a server device, substantially as hereinbefore described with reference to FIGS. 3 and 4 of the accompanying drawings.

25. A client device substantially as hereinbefore described with reference to FIGS. 3 and 4 of the accompanying drawings.

26. A server device substantially as hereinbefore described with reference to FIGS. 3 and 4 of the accompanying drawings.

27. A system comprising at least a client device and a server device, substantially as hereinbefore described with reference to FIGS. 3 and 4 of the accompanying drawings.

28. An authorisation portal substantially as hereinbefore described with reference to FIGS. 3 and 4 of the accompanying drawings.
